(19) United States
(12) Patent Application Publication
(10) Pub. No.: US 2012/0269097 A1
(43) Pub. Date: Oct. 25, 2012

(54) Method and apparatus for modifying caller identification data using interactive voice recognition and/or dual tone-multi-frequency signal processing in the core voice over internet protocol network

(76) Inventor: Louis Anthony Golato, Wildwood Crest, NJ (US)

(21) Appl. No.: 13/090,224

(22) Filed: Apr. 19, 2011

(51) Int. Cl. H04L 12/16

(52) U.S. Cl. 370/259

(57) ABSTRACT

Method and apparatus for modifying caller identification data using Interactive Voice Recognition (IVR) and/or Dual Tone Multi-Frequency (DTMF) signal processing in the core voice over internet protocol network

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

The present invention relates generally to communication networks and, more particularly, to a method and apparatus for modifying caller identification data using Interactive Voice Recognition (IVR) and/or Dual Tone Multi-Frequency (DTMF) signal processing in the core Voice over Internet Protocol (VoIP) network.

### BACKGROUND OF THE INVENTION

Inbound callers to a VoIP network will sometimes need to use Interactive Voice Recognition (IVR) and/or Dual Tone Multi-Frequency (DTMF) signals while a call is in progress to modify the information displayed on the caller identification display. For instance, in a VoIP network containing extensions going to several different hotels, an inbound caller can indicate the number of people in their party and the number of nights they are looking to stay. This information can be displayed on all extensions, and the hotels can answer the call based on their ability to satisfy the caller's needs.

Therefore, a need exists for a method and apparatus for modifying caller identification data using Interactive Voice Recognition (IVR) and/or Dual Tone Multi-Frequency (DTMF) signal processing in the core VoIP network.

### SUMMARY OF THE INVENTION

The present invention is a method and apparatus for modifying caller identification data using Interactive Voice Recognition (IVR) and/or Dual Tone Multi-Frequency (DTMF) signal processing in the core voice over internet protocol network.

### BRIEF DESCRIPTION OF THE DRAWINGS

FIG. 1 is a view of a typical caller id display.

FIG. 2 is a view of 3 examples of caller id displays showing data that was displayed based on caller input at various prompts.

FIG. 3 is a diagram showing the flow of 3 example calls.

### DETAILED DESCRIPTION OF THE INVENTION

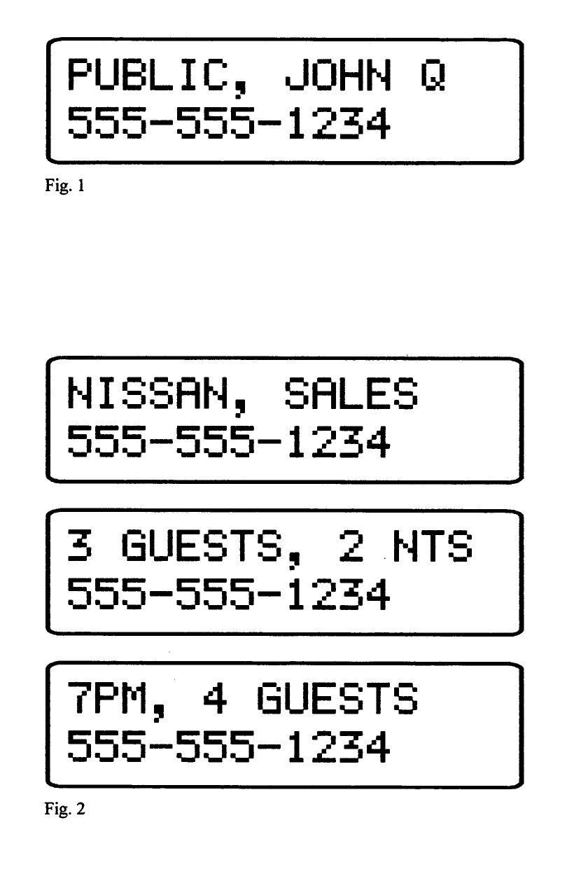

Referring now to the invention in more detail, in FIG. 1 there is shown the typical information transmitted from the caller's telephone and displayed on a caller identification display.

In further detail, in FIG. 2 there is shown 3 examples of data displayed based on callers input.

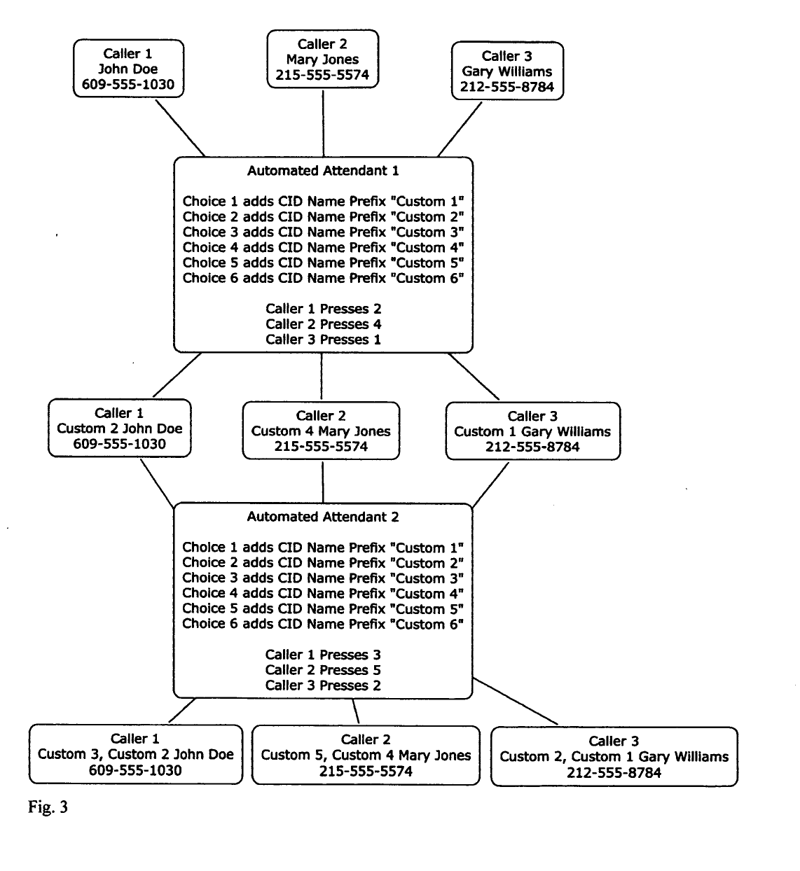

In further detail, in FIG. 3 there is shown the flow of 3 telephone calls with new data being added to the caller identification system based on the caller's input.

The advantages of the present invention include, without limitation, enabling people answering the calls to see what choices the caller has made before deciding weather or not to answer the call.

These callers may also be placed in a calling queue or sent to multiple telephones at the same time, allowing the call to be answered by someone who is aware of the caller's specific request.

In one embodiment, the present invention enables callers to modify data displayed on caller identification display using Interactive Voice Recognition (IVR) and/or Dual Tone Multi-Frequency (DTMF) signal processing in the core VoIP network.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A method for modifying caller identification data using Interactive Voice Recognition (IVR) and/or Dual Tone Multi-Frequency (DTMF) signal in a voice over internet protocol communications network; comprising: receiving the dual tone multi frequency signal by the voice over internet protocol communications network and modifying the existing caller identification data.

2. The method of claim 1, wherein the Interactive Voice Recognition (IVR) and/or Dual Tone Multi-Frequency (DTMF) signal is within a voice media transmission stream.

3. The method of claim 1, wherein the server is an application server.

4. The method of claim 1, wherein the server is a media server.

5. An apparatus for modifying caller identification data using Interactive Voice Recognition (IVR) and/or Dual Tone Multi-Frequency (DTMF) signal in a voice over internet protocol communications network; comprising: means for receiving the dual tone multi frequency signal by the voice over internet protocol communications network; means for modifying the existing caller identification data.

6. The apparatus of claim 5, wherein the Interactive Voice Recognition (IVR) and/or Dual Tone Multi-Frequency (DTMF) signal is within a voice media transmission stream.

7. A computer-readable medium having stored thereon a plurality of instructions, the plurality of instructions including instructions which, when executed by a processor, cause the processor to perform a method for modifying caller identification data using Interactive Voice Recognition (IVR) and/or Dual Tone Multi-Frequency (DTMF) signal in a voice over internet protocol communications network; comprising: comprising: receiving the dual tone multi frequency signal by the voice over internet protocol communications network and modifying the existing caller identification data.

8. The computer-readable medium of claim 7, wherein the Interactive Voice Recognition (IVR) and/or Dual Tone Multi-Frequency (DTMF) signal is within a voice media transmission stream.

9. The computer-readable medium of claim 7, wherein the server is an application server.

10. A system for modifying caller identification data using Interactive Voice Recognition (IVR) and/or Dual Tone Multi-Frequency (DTMF) signal in a voice over internet protocol communications network; comprising: receiving the dual tone multi frequency signal by the voice over internet protocol communications network and modifying the existing caller identification data.
